(19) United States
(12) Patent Application Publication
(10) Pub. No.: US 2003/0120680 A1
(43) Pub. Date: Jun. 26, 2003

(54) Method for directly providing content and services via a computer network

(76) Inventors: Rakesh Agrawal, San Jose, CA (US); Roberto Javier Bayardo, Morgan Hill, CA (US); Daniel Frederick Gruhl, San Jose, CA (US); Amit Somani, San Jose, CA (US); Ramakrishnan Srikant, San Jose, CA (US); Yirong Xu, Sunnyvale, CA (US)

Correspondence Address: Marc D. McSwain, IBM Corporation, Intellectual Property Law C4TA/J2B, 650 Harry Road, San Jose, CA, 95120-6099, US

(21) Appl. No.: 10/295,717

(22) Filed: Nov. 15, 2002

Related U.S. Application Data
(60) Provisional application No. 60/332,651, filed on Nov. 16, 2001.

(51) Int. Cl. G06F 7/00

(52) U.S. Cl. 707/103 R

(57) ABSTRACT

A system, method, and business method for operating a computer as a server for directly providing content and services via a computer network, by assigning a URL to the computer, associating at least one directory in a storage device with the URL, directing access requests from said URL to the directory, and delivering requested content and services, potentially for revenue. The content may be dynamic and contained in a database. The services may include storing data. The directory may be replicated onto additional computers to which access requests may be directed. Access requests may be authenticated as coming from members of a peer group having access rights. The invention features a one-click process for publishing content to an intranet or the internet, and employs known file transfer protocols.

### CROSS-REFERENCE TO RELATED APPLICATIONS

This application is related to commonly-owned provisional patent application, U.S. Ser. No. 60/332,651, “Method for Directly Providing Content and Services via a Computer Network”, filed on Nov. 16, 2001, which is hereby incorporated by reference. An article entitled “uServ: A Web Hosting and Content Sharing Tool for the Masses” submitted with the provisional application is to be considered an Appendix to this specification.

### FIELD OF THE INVENTION

This invention relates to providing content and services to users of a computer network such as the internet directly from a provider's computer using existing file transfer protocols.

### BACKGROUND OF THE INVENTION

One reason the internet has become very popular is that the it makes content access extremely easy. People want to share files over the internet. Whether the files are simple web pages, audio clips such as MP3's, photographs, or other content, the preferred means for sharing files is via the web. While the web makes accessing content simple, as almost anyone can use a browser, publishing content on a computer network like the web is more expensive and difficult. Prior efforts to solve this problem suffer from the following disadvantages:

Special purpose software must be installed.

Availability is limited when a user's own computer, which acts as a server, is turned off or is isolated by network outages.

Firewalled users, or other users who cannot accept inbound connections, can't publish content from their own computers.

Fee-based web hosting companies charge substantial fees for service and storage, yet free web hosting systems impose restrictive storage quotas or rely on repulsive advertising to help defray their costs.

Internet service providers sometimes assign IP addresses dynamically, making it harder for a content requester to find a given content publisher's content.

Technical complexity requires users to be skilled in computer networking and software installation and operation, which is a barrier to unsophisticated content publishers.

An invention that directly provides content and services via a computer network and eliminates these difficulties is needed.

### SUMMARY OF THE INVENTION

Accordingly, it is an object of the present invention to provide a method for directly providing content and services via a computer network. The invention uses existing internet protocols (e.g. HTTP and DNS) without special extensions, and allows a group of content publishers to pool their computing resources to increase availability and to perform peer-to-peer proxying. The invention reduces the high costs of current fee-based external server dominated solutions by moving almost all of the computational workload and storage requirements to individual users'computers. Location-independent domain names that allow content requesters to be directed to desired content are employed by the invention to resolve the dynamically assigned IP address problem.

The invention assigns a URL to a content publisher's computer, which operates as a server for directly providing content and services via a computer network, and which may be a conventional personal computer. The invention then associates at least one directory in a storage device with the URL, directs access requests from the URL to the directory, and delivers requested content and services. The storage device may be a CD-ROM, a DVD-ROM, a tape device, or a direct access storage device. The content publisher can also store content in a database. The content can be dynamically created, or may be updated in response to the number of access requests received. Content can include any kind of data files, including but not limited to such as photographs, text, audio files, web pages, and catalogs.

The services provided by the invention may include storing data, e.g. hosting submitted files to be shared with others. The directory may be replicated onto additional computers to which access requests may be directed, assuring high availability. Access requests may be authenticated as coming from members of a peer group having access rights. The invention features a one-click process for allowing even technically unsophisticated users to quickly and easily publish content to an intranet or the internet, and serves as an alternative to transmitting potentially large attachments via e-mail.

The invention also forms the basis for an e-commerce business method wherein either content publishers or content requesters pay for the operation of the invention. Different costs may be assigned to different tasks, such as providing dynamic content, replicating the directory onto additional computers to which content requests are redirected, and authenticating access requesters. The invention therefore provides an alternative to existing business models for providing content and services via a computer network, such as an intranet, the internet, or a virtual private network.

### BRIEF DESCRIPTION OF THE DRAWINGS

FIG. 1 depicts a default home page generated for each user, according to an embodiment of the present invention.

FIG. 2 depicts a simple one-click process enabling a user to publish a file on a computer network, according to an embodiment of the present invention.

FIG. 3 depicts a listing of a directory made accessible by an embodiment of the present invention, including the option to download all directory files as a single .zip file in one click.

FIG. 4 depicts a GUI-based file access report, according to an embodiment of the present invention.

FIG. 5A depicts the process of a peer node that can accept inbound connections coming online, according to a first embodiment of the present invention.

FIG. 5B depicts the process of accessing content from a peer node that can accept inbound connections, according to a first embodiment of the present invention.

FIG. 6A depicts the process of a peer node going offline and another node that replicates the site taking over, according to a second embodiment of the present invention.

FIG. 6B depicts the process of accessing content from a site whose peer node is offline, according to a second embodiment of the present invention.

FIG. 7A depicts the process of a peer node that cannot accept inbound connections coming online, according to a third embodiment of the present invention.

FIG. 7B depicts the process of accessing content from a peer node unable to accept inbound connections, according to a third embodiment of the present invention.

### DETAILED DESCRIPTION OF THE INVENTION

The software implementation of the present invention is referred to throughout this application as “uServ”, which is an internal IBM Corporation project name.

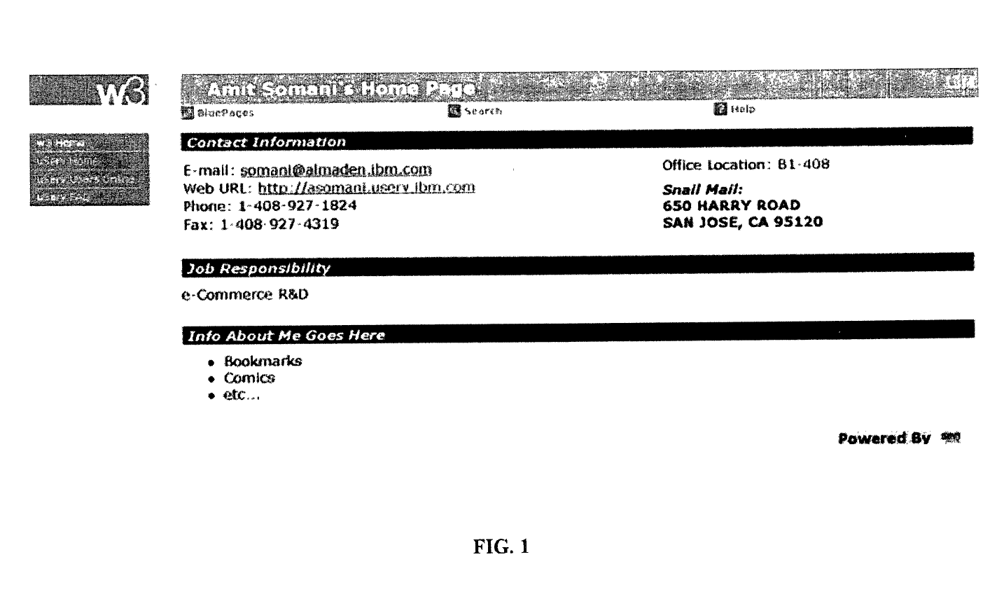

Referring now to FIG. 1, a default home page generated for each user is shown, according to an embodiment of the present invention. The invention is described in terms of a corporate intranet deployment. In most companies, each employee has a unique e-mail address. This address also often has a direct mapping to an “Intranet ID” that is used for accessing various web-based applications. The invention automatically assigns a domain name or URL for every employee based on this ID. For example, the e-mail address “bayardo@us.ibm.com” maps to the domain name “bayardo.userv.ibm.com”. Thus, locating someone's uServ web site is as trivial as looking the person up in the employee directory or remembering his or her e-mail address.

Once a user downloads and runs the uServ installer, the software implementation of the invention starts up and requests this intranet ID and password for login. Unless the user specifies otherwise, the invention remembers the login information and connects automatically every time the software is restarted. After the initial login, the invention creates a brand new empty directory (i.e. a shared folder) and populates this directory with a default homepage and a private subdirectory. The default homepage is typically populated with information extracted from the corporate personnel directory, and may include the employee's name, job title, phone number, mailing address, etc. as shown. The user can manually change the shared folder's location and content at any time.

The invention restricts web access to the private subdirectory by requiring the username and password which was entered during login. All other files in the shared folder or directory can be accessed without a password as long as the URL is known. Alternative access control schemes are possible. Access control is non-trivial in an environment where peers directly host content. In order to avoid compromised passwords, login information should never be directed to peers, but instead validated by a trusted third party.

The creators of the invention adopted the philosophy that any system designed for the masses has to be extremely simple to use in every respect. It typically takes less than 10 minutes for an individual who knows how to use a browser to make their first file accessible on the web using the invention, including the time required to download and install the software implementation.

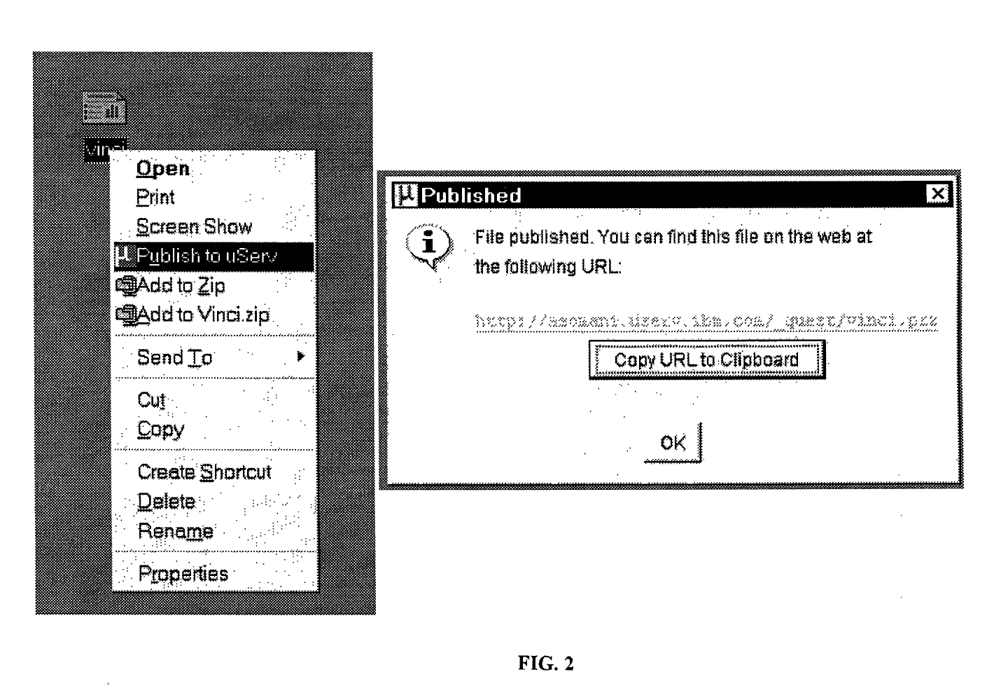

Referring now to FIG. 2, a simple one-click process enabling a user to publish a file on a computer network is shown, according to an embodiment of the present invention. In order to share a file, a user can either copy it to his or her shared directory, or use a specific feature which makes sharing even easier. With this one-click feature, the user can simply right-click over the file and select “Publish to uServ” as shown. The user is then prompted to choose a specific subdirectory in which to save the file, after which the file is written to the shared space and a URL pointing to that file provided to the user. This URL can be launched or copied to the clipboard with one click, making it easy to share the URL with others via e-mail or instant messaging.

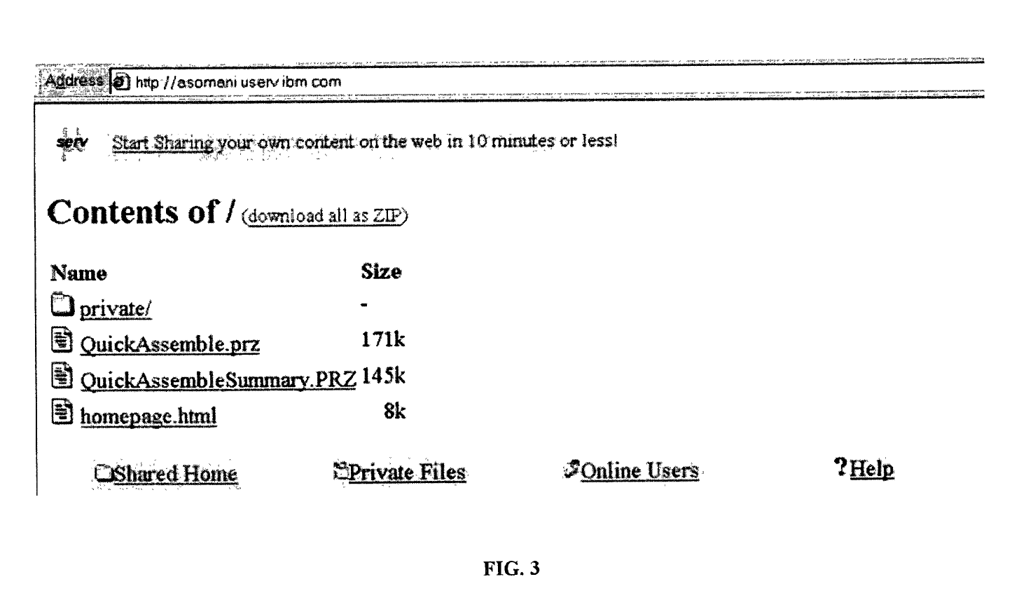

Referring now to FIG. 3, a listing of a directory made accessible by an embodiment of the present invention is shown, including the option to download all directory files as a single .zip file in one click.

When a user vists a uServ site, the invention will by default list the shared folder contents as shown. Most people like to share files without maintaining sophisticated HTML pages linking to them. Directory browsing allows users to find content without having to remember the exact URL. Users who do maintain HTML links to their content can rename their homepage.html file (or another file) to index.html in order to have that file served in place of a directory listing. This behavior is consistent with that of other webserver software. One unique feature of the software implementation of the invention is that it allows site visitors to download the entire contents of a shared directory hierarchy (excluding the private subdirectory) with one click in ZIP format (note the “download all as ZIP” link in FIG. 3). Most users find creating ZIP files manually to be a cumbersome task, thus the feature is quite valuable when sharing multi-file content such as photo albums or source code trees.

Directory listings always provide links back to the home site, as do the automatically generated home pages. The invention also maintains an up-to-date listing of users whose sites are available, and whether or not those sites are being served directly by the site owner or via a site replica (to be described below).

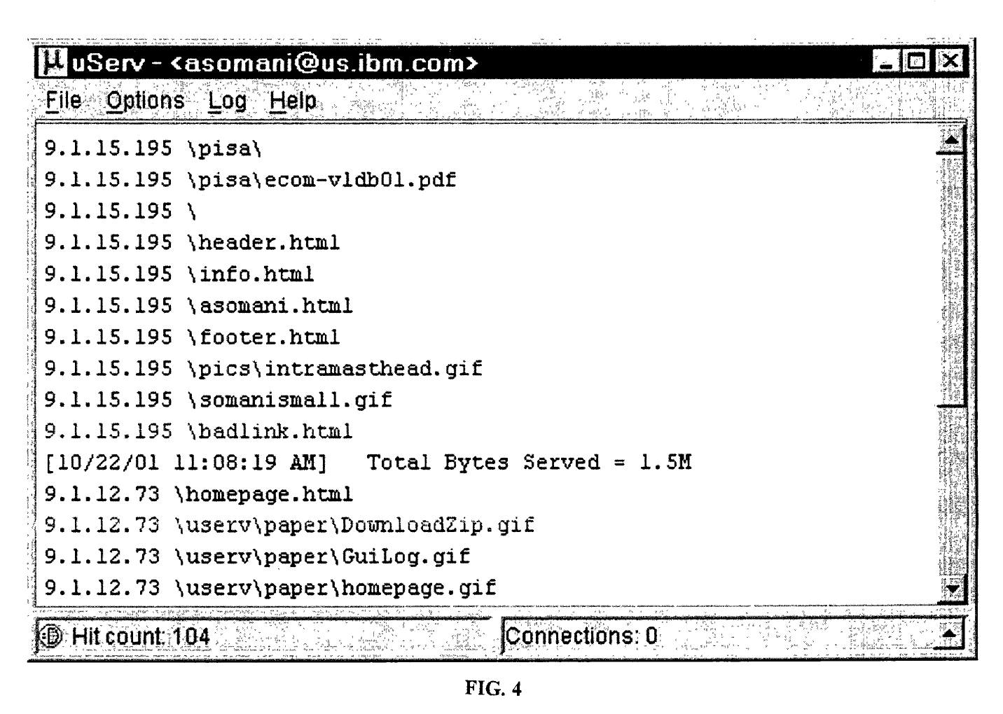

Referring now to FIG. 4, a GUI-based file access report is shown, according to an embodiment of the present invention. The uServ graphical user interface displays a log which lists which files have been accessed, when, and from which IP address. The idea is to make it easy for a user to see when his or her content has been accessed. The GUI log also flags error requests (such as ‘file not found’) in red, which facilitates site debugging. These features of the invention provide distinct advantages over other file-sharing methods, such as e-mail attachments which may remain unopened without the sender ever knowing. Users who are not interested in monitoring site access can simply close the GUI window. A control-tray icon allows the GUI to be restored as desired.

Different embodiments of the present invention are now described, according to whether they employ various features. The common components of the system of the present invention include:

uServ peer nodes—these are the computers of the individuals who have set up a site by running the uServ peer software. These components do all of the “heavy lifting” in that all content is served directly from them, not any centralized server-provided resource.

Browser—A standard web browser for accessing content.

uServ coordinator—a centralized component that provides user authentication, proxy and replica matchmaking, IP sniffing and firewall detection, site availability monitoring, and other “administrative” tasks. The coordinator is the first contact point of any uServ peer node, which must authenticate itself before uServ will set up the appropriate domain name to IP mapping with the dynDNS component.

dynDNS—a centralized component that speaks the DNS protocol for resolving uServ domain names to computer IP addresses. The communication protocols used by the invention are DNS and HTTP (for supporting standard web browsers).

With typical personal webserver deployments, once the user's computer is turned off or removed from the network, the content the user wants to provide is no longer accessible to others. This greatly hinders asynchronous collaboration, wherein it is not known exactly when a shared file will need to be downloaded. The present invention therefore supports the concepts of site replication and shared hosting in order to overcome this limitation.

Any user of the invention can list other users (“slaves”) who are willing to host their content when the user is offline. These other users must also list the users whom they are willing to host (“masters”), thereby enforcing a two-way agreement. Many groups or teams have at least one member who is willing to leave a desktop computer running continuously. This member is typically used as a slave by the other members of the team. Some people have multiple computers, e.g. a desktop and a laptop computer. These people tend to use their desktop computer as a slave system and maintain the master copy of their site content on their more mobile laptop.

Site replication is performed transparently to the user. Once the masters and slaves are specified, replicas synchronize with the master site automatically, and replicas are activated automatically by the uServ coordinator when the user disconnects, even when the user does not “properly” shut down. The use of replicas is also transparent to content requesters. Regardless of who is actually serving someone's content, it is always accessed through the same location independent URLs.

The uServ peer nodes are themselves entirely responsible for the bulk of replica maintenance. The uServ coordinator's job with respect to this task is simply to provide the contact information and authenticating tokens necessary for sites to directly (or via a proxying peer node) communicate with one another. Because of the obvious security implications, the invention requires permission be granted in both directions before the coordinator will activate a site replica. That is, a uServ user must designate other uServ users who are allowed to host his content, and also those users whose content he is willing to serve.

The site synchronization scheme employed is designed with the assumption that the typical site change involves the addition or removal of files from a site, with file modifications taking place less frequently. In most cases, this scheme requires very little data to be exchanged between sites in order to keep a replica up to date. Some users in a local deployment are maintaining replicas of several gigabytes and tens of thousands of files. In the preferred synchronization scheme, slave sites (sites which host replicated content) initiate contact with their master sites, and also initiate content sychronization when necessary. A slave determines when its replicated content is out of date by periodically comparing a short summary of its replicated content with the master's summary. If these summaries fail to match, the slave site will proceed by providing a more detailed summary to the master which allows it to determine precisely which directories need to be updated or deleted. For each directory that needs to be updated, the slave summarizes the directory contents in order to determine precisely which files need to be updated or deleted. For each file that needs to be updated, the slave site will download the file completely from the master site using a standard HTTP GET request.

While checking for site synchronization, slaves also effectively monitor the availability of their masters. Should any of its masters go offline, a slave will immediately notify the uServ coordinator. The uServ coordinator also monitors site availability, but it must do so on a much larger scale. The slave's assistance in this task reduces site unavailbility due to situations such as improper shutdown of a uServ site or network problems, and is consistent with the attempt to reduce the centralized roles of the invention in order to minimize the cost of providing the service.

Some users have computers that cannot accept what are known as “inbound port 80 connections”. Rather than going into the technical details of this term, at this point it is merely noted that inbound port 80 connections must be allowed for standard web server software to function. Several reasons prevent inbound port 80 connections, the most common of which is firewall software which many corporate security guidelines mandate be installed on any mobile (e.g. laptop) computer. While firewall software can often be configured to allow port inbound 80 connections, quite often this configuration step is beyond the capability of the average user. Virtual private networks (VPNs), network address translators (NATs), and even the presence of other webserver software running on the same computer can also forbid or otherwise prevent a computer from accepting inbound port 80 connections.

The invention resolves this matter by implementing peer-to-peer proxying. Put simply, other members of the uServ community who can accept inbound port 80 connections provide content on behalf of users who cannot. These other users are referred to as “proxies”. By default, any user who runs uServ is willing to serve as a proxy for up to four other users. Users can change this limit or even disable the feature completely. The software implementation of the invention detects if a proxy is needed when it first starts up. Should a proxy be needed, the uServ coordinator forwards the contact information of another uServ user (i.e. a peer) who is willing to serve as a proxy. The system connects to that user's computer, which will then accept connections on behalf of the first user. As with replication, the use of proxies completely transparent to the end user. Whenever a proxy is used, uServ will non-intrusively notify the user via its GUI which particular user is serving as the proxy, and also encourages the user to check if his or her computer can be reconfigured so that proxying is not necessary. The invention also informs users who serve as proxies when and for whom they are serving. In local testing, a large majority of users (>80%) have been willing to serve as proxies for the community. In most cases, a user notices no performance or bandwidth degradation when serving as a proxy, because proxying only consumes significant bandwidth when someone is actually downloading files from the proxied user's site.

The invention takes advantage of a dynamic DNS so that a browser can map the assigned domain names to the location (IP address) of an available peer node capable of serving the requested content. In a typical scenario, the DNS maps a domain name to the computer of the user to whom the domain name belongs. However, should this machine be offline, it could instead map to another uServ peer node that is capable of serving the content from a site replica. In the third case, if the user's machine is firewalled, the system could instead map to a computer which is serving as a proxy for the site.

The software implementation of the invention uses BIND to provide the dynamic DNS service. Recent versions of BIND allow updates to be performed on a running nameserver. This allows the uServ coordinator component to immediately push any updates to the DNS server. These entries have a very short time to live (2 minutes), assuring that changes in the hosting machine are quickly propagated (e.g. if the host goes off line and a replica takes over).

Some DNS servers and most browsers do not properly abide by the time-to-live (TTL) contract for caching DNS mappings. The result is that sometimes a uServ site can become inaccessible for several minutes when a replica of the site is just activated, or the IP address of the site changes. This problem is for the most part a minor nuisance which affects a very small percentage of all accesses to uServ sites. An individual uServ site which is not heavily accessed is unlikely to have its IP address cached within a browser or a local nameserver when it is accessed. Further, users aware of the problem can typically cure it by launching a new browser instance, since indiscriminate caching of DNS entries by the browser is usually the culprit.

The invention uses a 2 minute TTL, which means that uServ DNS entries should be cached for at most 2 minutes, allowing a replica to become accessible by users very shortly after it is activated by the coordinator. In a perfect world, site inaccessibitliy can be eliminated completely by implementing a delayed shutdown wherein a uServ peer node remains running for 2 minutes after activating a replica. Some DNS server software unfortunately allows configurations that override low TTL values with a global minimum. Most popular browsers ignore TTL values completely and use their own fixed cache timeout settings. A handful of nameservers have been identified which appear to be configured to use no less than a 5 minute TTL. Even worse, the Netscape browser caches DNS entries for 15 minutes by default. Internet Explorer appears to use a similar caching policy. Rumor has it these unfortunate caching schemes were implemented within browser software because one cannot get TTL information from the DNS libraries on Windows-based machines. This problem is not one unique to uServ, but also affects systems such as dynamic DNS services. As dynamic IP address assignment and services impacted by dynamic IP address assignment become more common, it is likely that operating system libraries, DNS servers and their configuration, and browser implementations will adapt by properly abiding by the DNS protocol.

Three different exemplary embodiments of the invention are described in more detail:

1. Basic: A peer node is online and capable of accepting inbound connections, and therefore serves its own site.

2. Peer-hosted: A peer node is offline and a replica of its site is served by another peer node.

3. Proxied: A peer node is online but unable to accept inbound connections, and therefore serves its site through a proxy which accepts connections on its behalf.

While separate embodiments are described in terms where peer nodes may serve as a proxy or replica to a single other peer, it should be noted that in the best mode of the invention a peer node is actually capable of serving as a proxy for multiple users at once, and/or also serving site replicas of multiple users.

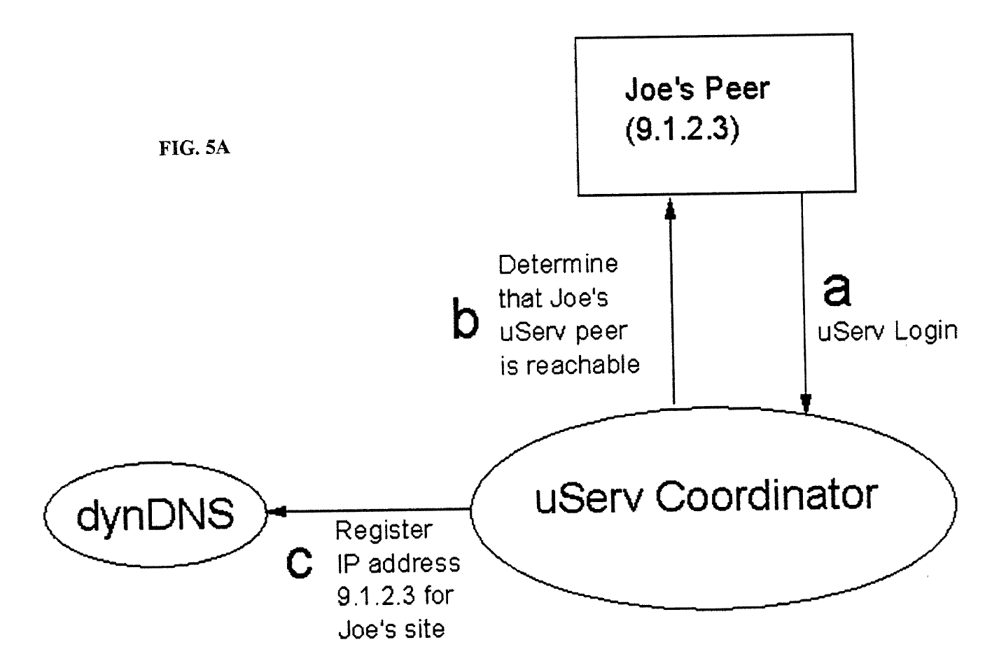

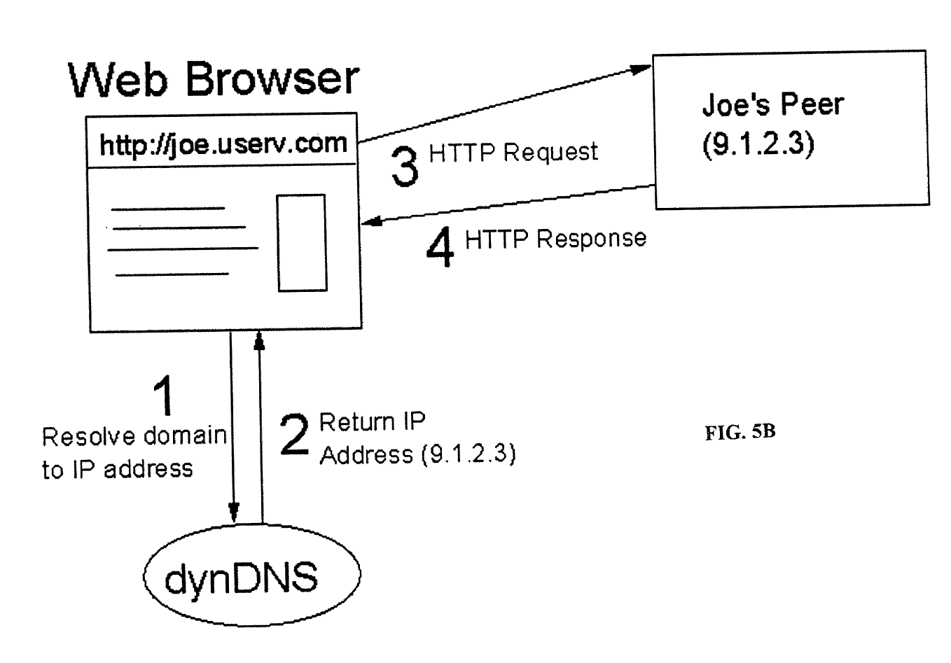

Referring now to FIG. 5A, the process of a peer node that can accept inbound connections coming online is shown, according to a first embodiment of the present invention. FIG. 5A depicts the initialization step for the first scenario, where a user is capable of accepting inbound connections. The peer, in the depicted case run by a user named Joe, comes online and authenticates itself with the uServ coordinator in step (a). In step (b), the uServ coordinator successfully establishes a connection back to Joe's peer node which signals that it can accept inbound connections. The coordinator immediately updates the DNS entry of Joe's site with the IP address Joe's machine in step (c).

Referring now to FIG. 5B, the process of accessing content from a peer node that can accept inbound connections is shown, according to a first embodiment of the present invention. In FIG. 5B, a browser attempts to access Joe's site. The browser resolves Joe's domain name (in step 1) to Joe's machine (in step 2), and executes (in step 3) an HTTP request to retrieve the desired content (in step 4). Though the figure depicts the browser communicating directly with the uServ DNS, the DNS protocol allows the browser to communicate with a local nameserver. Ultimately, however, the domain name to IP mapping information arises from this uServ dynamic DNS component.

This basic scenario is what is provided by dynamic DNS services existing on the internet today (minus the inbound connection check). The present invention is unique in that it can also serve content in the two remaining ways for higher availability.

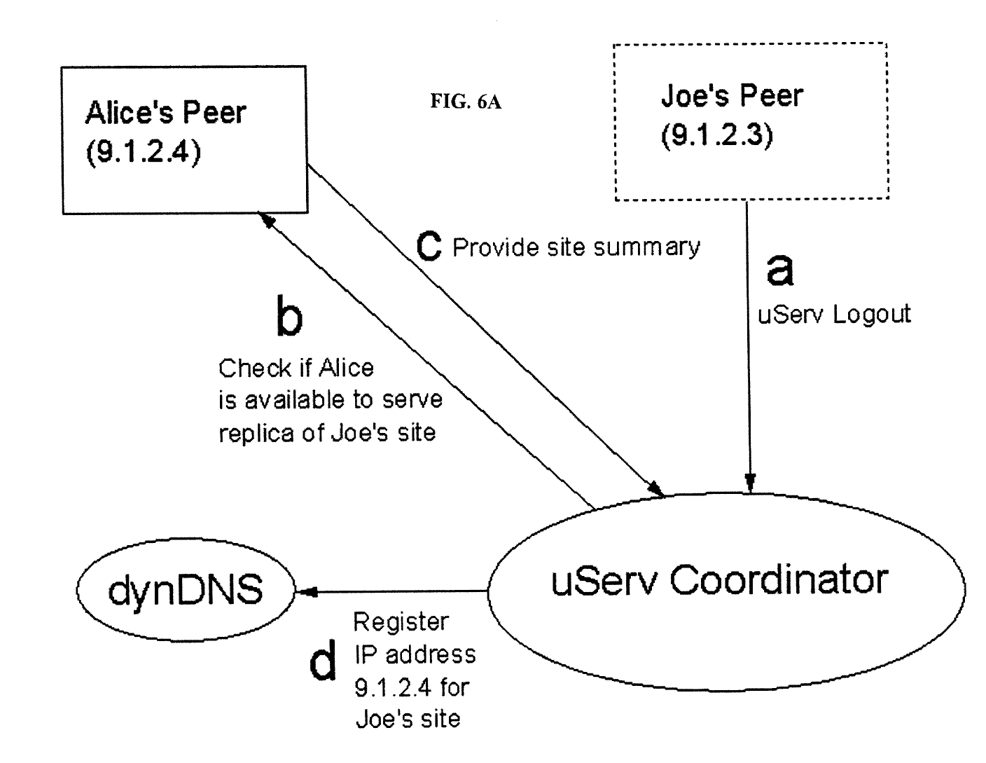

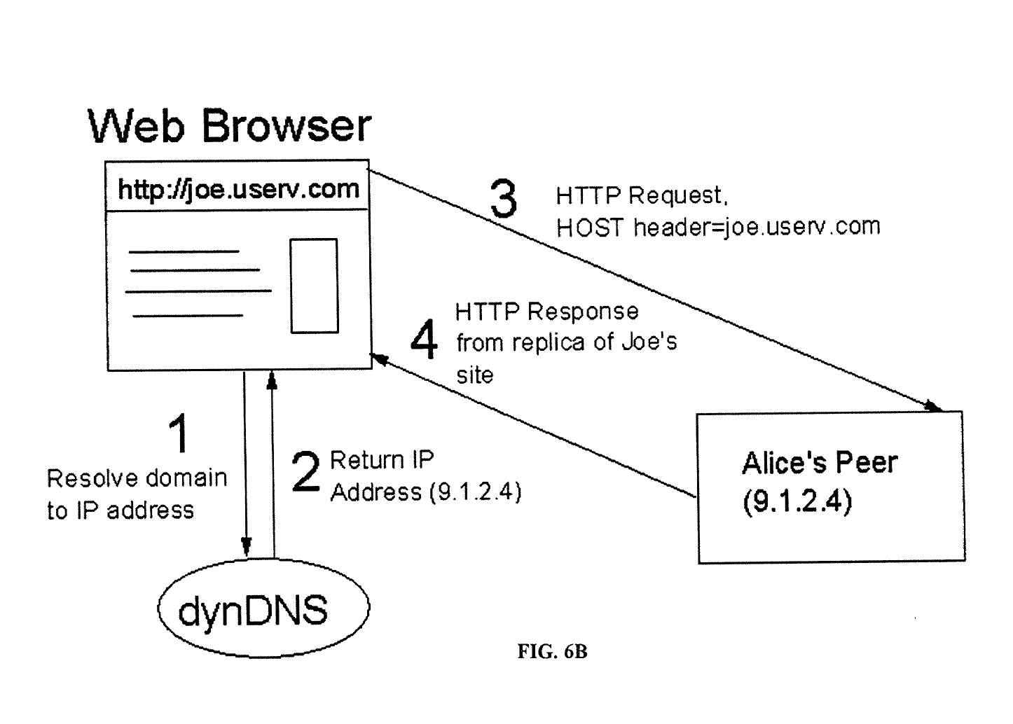

Referring now to FIG. 6A, the process of a peer node going offline and another node that replicates the site taking over is shown, according to a second embodiment of the present invention. Some time before Joe's computer goes offline (for whatever reason), Joe and Alice have agreed to allow Alice's peer node to serve Joe's content while Joe's peer node is unavailable. When Joe disconnects in step (a), the coordinator will check in step (b) if Alice is available and willing to serve Joe's content. Alice indicates willingness in step (c) by returning a site summary (essentially a checksum plus timestamp) of Joe's site. The coordinator may use this summary to determine whether to activate Alice's replica. In one implementation, if Alice is the only replica, the coordinator will activate her replica unconditionally. The summaries are only used to determine which of multiple replicas are the most up-to-date. Assuming Alice is the only available replica, the coordinator activates the replica by updating the IP address for Joe's site to the address of Alice's computer in step (d). Should no replica of Joe's site be immediately available, the coordinator will monitor newly active peers in case one should come online.

Referring now to FIG. 6B, the process of accessing content from a site whose peer node is offline, according to a second embodiment of the present invention. After the replica of Joe's site is activated on Alice's computer, web requests for Joe's content (in step 1) are directed to Alice's peer node (in step 2). In step 3, Alice's peer node checks the value of the HTTP HOST header within the incoming request. Browsers will set the HOST header value to the domain name used to resolve the IP address of the requested site. In this case the web request will contain Joe's domain name, which causes Alice's peer node to return the requested content from the replica of Joe's site, in step 4.

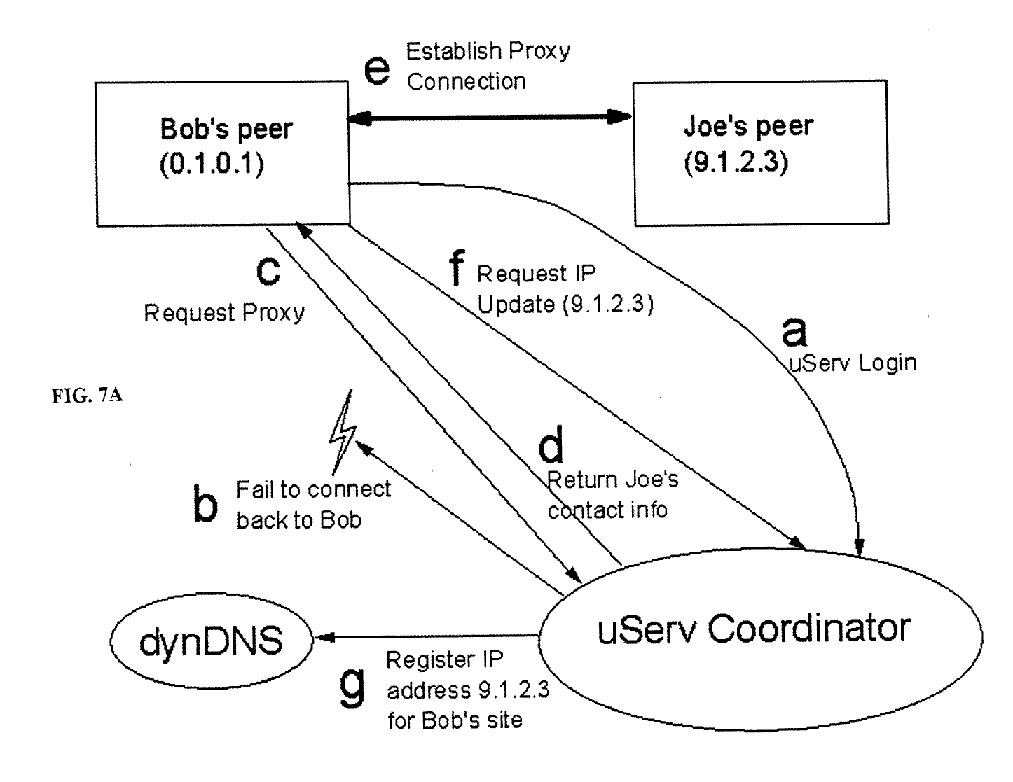

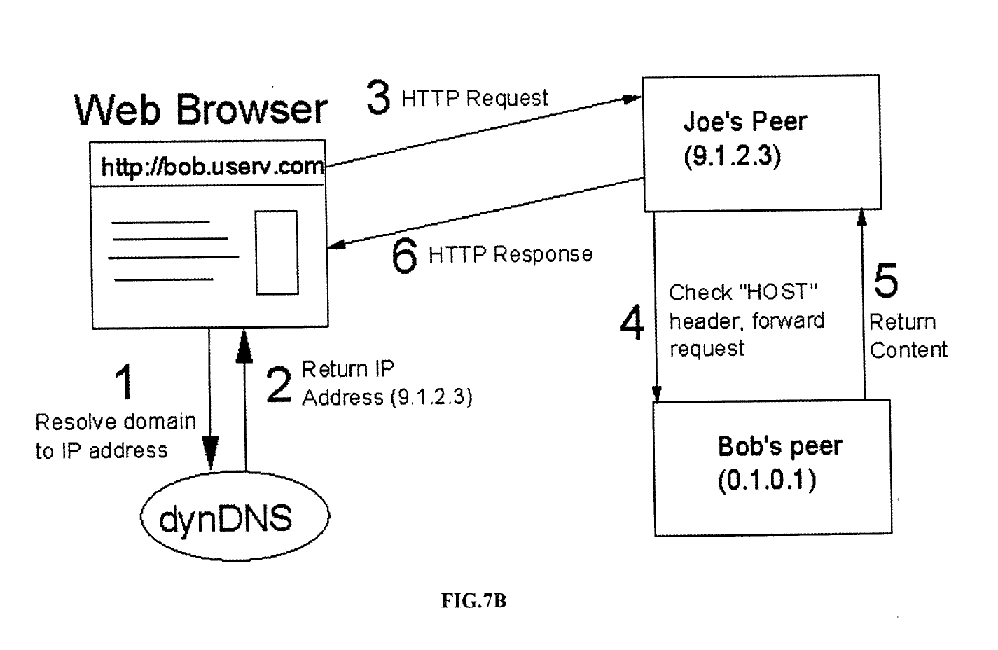

Referring now to FIG. 7A, the process of a peer node that cannot accept inbound connections coming online is shown, according to a third embodiment of the present invention. In this final, imagine again that Joe is online and capable of accepting inbound connections. Another user, Bob, comes online and registers with the coordinator in step (a), which is unable to open a new connection back to him in step (b). Bob's peer node recognizes that it didn't receive the expected connection from the coordinator, indicating it is incapable of accepting the necessary inbound connections to serve its own content. Bob's peer node therefore requests that it be directed to an available proxy in step (c). The coordinator responds in step (d) with contact information of an available proxy, in this case Joe. The coordinator returns its response through the connection established by Bob, so an inbound connection is not needed to get this information to him. Contact information consists for the most part of an IP address and an authenticating token. Bob's peer node uses this contact information in step (e) to establish an outgoing, persistent connection with Joe's peer node, and reports back to the coordinator in step (f) that a proxy connection was successfully established. The coordinator updates the DNS entry of Bob's site with the IP address of Joe's peer node in step (g).

Referring now to FIG. 7B, the process of accessing content from a peer node unable to accept inbound connections is shown, according to a third embodiment of the present invention. FIG. 7B displays what happens when a browser attempts to access Bob's content. In the first two steps, the domain name is resolved to an IP address. However, in this case, the browser directs the HTTP request to Joe's peer node in step 3, which performs the HTTP HOST header check and determines the request is intended for Bob's content. In step 4, Joe forwards the request to Bob's machine through the previously established persistent connection (thereby not requiring it establish any inbound connections with Bob). In step 5, Bob returns the requested content to Joe who returns it back to the browser through the HTTP response in step 6.

The protocol spoken across the persistent proxy connection is not HTTP, but instead a uServ-specific protocol allowing multiple requests to be served in parallel on a single connection. A special protocol is used here because the HTTP protocol requires no more than one request be active at a time on a single connection. Browsers will often open multiple concurrent connections to a site at once to, for example, allow multiple images to load concurrently. By using a special protocol, uServ peers can parallelize proxied content requests while maintaining only a single persistent connection. This proxied protocol has the added benefit of not suffering from the high connection establishment overhead of multiple concurrent HTTP requests, thereby providing improved performance. Note that this special protocol need only be spoken between uServ peer nodes, and not by machines requesting the content.

Proxying is bandwidth intensive at times, which is why the invention delegates the task to peer nodes, thereby spreading the load across the entire system. A proxied request roughly doubles the bandwidth and latency required, and much of this bandwidth is consumed from the proxy's network connection. Note however that it is possible to have a proxy node cache frequently-requested content from the proxied user in order to lessen the consumed bandwidth and latency. Extending the proxying protocol to allow for such caching involves simply adding something similar to the HTTP HEAD request to the multiplexed download protocol to allow a proxy to determine if cached content needs to be refreshed.

Since firewalls typically block inbound but not outbound connections, another potential optimization is to have Bob directly forward the HTTP response back to the browser instead of routing it through Joe. The problem with this idea is that the HTTP protocol requires that the HTTP response travel down the same incoming connection as the request. It is possible in some situations to have Bob spoof the IP packets to make them appear as a response from Joe. Unfortunately, any hack involving IP spoofing would be foiled by software or hardware that performs IP rewriting, such as SOCKS proxies (which are commonly used for outbound firewall traversal) and network address translators.

Since the peer nodes do most of the work, the potential scalability bottlenecks in the invention lie primarily in the centralized DNS and coordinator components. The DNS entries in uServ have a low TTL, so many uServ site requests result in network traffic to the DNS component. The traffic to the DNS server roughly scales up with the number of content accesses, while the traffic for the coordinator component scales up with the number of uServ sites. Thus it is expected that the DNS component will become the primary bottleneck. Luckily, DNS is a lightweight, low bandwidth protocol for which many implementations (including BIND) are highly optimized. DNS also allows redundant servers be added if needed. The uServ coordinator could also be programmed to recognize sites which use static IP address and rarely if ever fail over to replicas, and heuristically increase the TTL value accordingly in order to reduce DNS traffic.

The coordinator component spends most of its time handling user authentication and site availability monitoring. As noted, however, the uServ peers assist in availability monitoring, and the invention could be extended to further push roles other than authentication to the peer nodes as scalability becomes a concern. Authentication thus becomes the primary bottleneck for the coordinator component. Each authentication requires the exchange of only a small amount of data (the encrypted userID and password) and a single database lookup. Assuming very conservatively that the system can handle 100 authentications per second and that each uServ site authenticates on average twice daily, the capacity of the coordinator would be over 4 million uServ sites.

Security is one of the primary concerns of users of the invention, with many of these concerns resulting from recent worm attacks on Microsoft's IIS web server software (e.g. Code Red and its variants). In addition to worms, users are are in particular worried about hackers who might exploit holes to install unauthorized programs on their computers, or to access files which were not designated for sharing. Other areas of concern include denial of service attacks and restricting access of certain content to designated users.

uServ is written in Java which makes it robust (if not immune) to buffer overflow attacks such as those used by Code Red and other hacking tools to install unauthorized programs. In addition, because of its content sharing focus, the uServ webserver implementation does not provide any scripting support, another common source of security holes.

Because the webserver within each uServ peer node is quite simple, there are only a few code paths which need to be thoroughly scrutinized in order to improve security. The present implementation provides only one code path through which all served content, for whatever purpose, is delivered to the network. This code path always explicitly verifies that any delivered content resides within the designated shared folder hierarchy.

The invention is more robust to denial of service attacks than a typical web hosting service. Because of its distributed nature, a denial of service attack must target multiple computers in order to take out a significant fraction of the system's content. While it is conceivable that uServ's DNS and coordinator components could be targeted, DNS is somewhat resilient to such attacks since IP addresses are cached in local nameservers, and the coordinator being unavailable does not affect existing sites, only sites which need to become activated. An individual uServ site with no replica is likely to be more prone than a hosted site to denial of service attacks since end-user computers typically have more limited bandwidth and compute power than those used by hosting services. Given a replica, though, the uServ coordinator or one of the peer node's slaves will likely lose contact with the site being attacked and trigger the replica to become active. The attack would thus have to keep track of DNS updates in order to succeed.

Users of the invention are admonished to publish only those files that they don't mind sharing with everyone in the corporation, because the invention does not currently offer access control functions other than a private folder protected by the ID and password used during uServ login. More sophisticated access control implementation in a peer-to-peer web hosted model such as uServ is non-trivial and remains an area of future work. Some anticipated difficulties and potential solutions are described below.

In addition to encrypting data that flows over the network, a secure access mechanism must authenticate users to sites and vice versa. Web protocols seamlessly allow browsers to authenticate websites to users and communicate with encrypted data through secure HTTP extensions and third-party issued security certificates. Site owners who want to offer encrypted and authenticated downloads from their site must purchase a security certificate from any of a number of these third-party certificate authorities. Unfortunately, web protocols provide no functions for authenticating users to websites other than a simple mechanism for having the browser prompt the user for an id and password when requesting secured content. Most websites thus implement their own authentication scheme by having the user register a user ID and password specifically for their site. It would be unwieldy and unreasonable for the system to require a user to register for a different password from each uServ site with which he requires secure access. The alternative is a single signon scheme, in which case the peer nodes cannot be responsible for authenticating users through passwords. If the sites themselves are responsible for authenticating users via any “uServ global” ID and password, then a malicious peer node could record the passwords presented to it, allowing it to impersonate any user that accesses its secured content.

Microsoft Passport is a single-signon scheme for the web in which a central site accepts passwords in order to authenticate users on behalf of its member sites. In this system, content on a member site requiring secure access forces a redirect to the Passport site, where the user must provide his or her login ID and password. The Passport system then redirects the user back to the member site with the user's authenticated identity encrypted in the redirect request. The member site never receives the user's password. Instead it decrypts the authenticating information provided by Passport in order to reveal the user's identity. Encrypting and decrypting of this user information within the redirect is performed via a symmetric key that has been previously established between Passport and the member site. The member site also sets a cookie in the user's browser so it can later determine if the user is already authenticated.

The uServ environment adds complications not addressed by the Passport proposal such as dynamic IP addresses and how to ensure access control remains transparent across the different content serving scenarios (direct, peer-hosted, proxied). Nevertheless, Passport may be a good starting point in designing an access control scheme for the present invention. The challenge lies in addressing these complications without requiring extensions of web and other internet protocols.

A general purpose computer is programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the invention has been described with respect to an illustrative embodiment thereof, it will be understood that various changes may be made in the apparatus and means herein described without departing from the scope and teaching of the invention. Accordingly, the described embodiment is to be considered merely exemplary and the invention is not to be limited except as specified in the attached claims.

We claim:

1. A method for operating a computer as a server for directly providing content and services via a computer network, comprising the steps of:
assigning at least one URL to the computer;
associating at least one directory in a storage device with said URL;
directing access requests from said URL to said directory; and
delivering content and services corresponding to said access requests.

2. The method of claim 1 wherein said services include storing data.

3. The method of claim 1 wherein at least one of said directing step and said delivering step employ known file transfer protocols.

4. The method of claim 1 comprising the further step of updating said content in response to a number of said access requests for said directory.

5. The method of claim 1 comprising the further step of replicating said directory onto at least one additional computer.

6. The method of claim 5 comprising the further step of directing at least one of said access requests to at least one of said additional computers.

7. The method of claim 1 comprising the further step of authenticating said access requests as coming from members of a peer group having access rights to said directory.

8. The method of claim 1 wherein said delivering step employs a one-click publication process.

9. An e-commerce business method for operating a computer as a server for directly providing content and services via a computer network, comprising the steps of:
assigning at least one URL to the computer;
associating at least one directory in a storage device with said URL;
directing access requests from said URL to said directory; and
delivering content and services corresponding to said access requests.

10. The method of claim 9 wherein said content is dynamic and contained in a database.

11. The method of claim 9 comprising the further step of replicating said directory onto at least one additional computer.

12. The method of claim 11 comprising the further step of directing at least one of said access requests to at least one of said additional computers.

13. The method of claim 9 comprising the further step of authenticating said access requests as coming from members of a peer group having access rights to said directory.

14. The method of claim 9 wherein originators of said access requests pay revenue for said services and content.

15. The method of claim 9 wherein providers of said content and services pay revenue for said assigning, associating, and directing steps.

16. The method of claim 15 wherein said revenue is a function of at least one of: whether said content is dynamic, whether said directory is replicated onto at least one additional computer, whether at least some of said access requests are directed to at least one of said additional computers, and whether said access requests are authenticated as coming from members of a peer group having access rights to said directory.

17. A system for operating a computer as a server for directly providing content and services via a computer network, comprising:
means for assigning at least one URL to the computer;
means for associating at least one directory in a storage device with said URL;
means for directing access requests from said URL to said directory; and
means for delivering content and services corresponding to said access requests.

18. A computer program product comprising a machine-readable medium having machine-executable instructions thereon including code means for operating a computer as a server for directly providing content and services via a computer network, said code means comprising:
a first code means for assigning at least one URL to the computer;
a second code means for associating at least one directory in a storage device with said URL;
a third code means for directing access requests from said URL to said directory; and
a fourth code means for delivering content and services corresponding to said access requests.

19. A system for directly providing content and services via a computer network, comprising:
a computer;
a computer network;
at least one URL assigned to said computer;
at least one directory in a storage device associated with said URL; and
an access director that directs access requests from said URL to said directory, wherein said computer delivers content and services corresponding to said access requests.

20. The system of claim 19 wherein said computer is a conventional personal computer.

21. The system of claim 19 wherein said content is dynamic and contained in a database.

22. The system of claim 19 wherein said services include storing data.

23. The system of claim 19 wherein said computer network includes at least one of: the internet, a virtual private network, and an intranet.

24. The system of claim 19 wherein said storage device is at least one of: a direct access storage device, a CD-ROM, a DVD-ROM, and a tape device.

25. The system of claim 19 wherein at least one of said access director and said computer employ known file transfer protocols.

26. The system of claim 19 wherein said computer updates said content in response to a number of said access requests for said directory.

27. The system of claim 19 further comprising at least one additional computer on which said directory is replicated.

28. The system of claim 27 wherein said access director directs at least one of said access requests to at least one of said additional computers.

29. The system of claim 19 wherein said access director authenticates said access requests as coming from members of a peer group having access rights to said directory.
